(19) United States
(12) Patent Application Publication
(10) Pub. No.: US 2024/0131696 A1
(43) Pub. Date: Apr. 25, 2024

(54) Robot Operating Device and Product Manufacturing System

(71) Applicants: TE Connectivity Solutions GmbH, Schaffhausen (CH); Tyco Electronics (Shanghai) Co., Ltd., Shanghai (CN)

(72) Inventors: Rong Zhang, Shanghai (CN); Dandan (Emily) Zhang, Shanghai (CN); Roberto Francisco-Yi Lu, Bellevue, WA (US); Zongjie (Jason) Tao, Shanghai (CN)

(73) Assignees: TE Connectivity Solutions GmbH, Schaffhausen (CH); Tyco Electronics (Shanghai) Co., Ltd., Shanghai (CN)

(21) Appl. No.: 18/493,244

(22) Filed: Oct. 23, 2023

(30) Foreign Application Priority Data
Oct. 23, 2022 (CN) 202211302170.6

(51) Int. Cl. B25J 9/16; B25J 9/00; B25J 15/00

(52) U.S. Cl. CPC B25J 9/162; B25J 9/0009; B25J 9/0084; B25J 15/0009

(57) ABSTRACT

A robot operating device includes a mobile vehicle, a guide rail installed on the mobile vehicle, and a plurality of robots slidably installed on the guide rail and movable along the guide rail. The mobile vehicles each include a mobile base having a roller at a bottom thereof, and a fixed bracket installed on the mobile base. The guide rail is fixedly installed on the fixed bracket and extends in a horizontal direction. The plurality of robots are adapted to manipulate a product manufacturing machine to manufacture products.

### CROSS-REFERENCE TO RELATED APPLICATION

This application claims the benefit of Chinese Patent Application No. CN202211302170.6 filed on Oct. 24, 2022, in the State Intellectual Property Office of China, the whole disclosure of which is incorporated herein by reference.

### FIELD OF THE INVENTION

The present invention relates to a robot operating device and a product manufacturing system including the robot operating device.

### BACKGROUND

In the prior art, when using a machine equipment to manufacture products, for example, when using CNC machine tools to process products, it is usually necessary for operators to operate the machine equipment on site. However, using operators on site can lead to increased costs and low production efficiency. In addition, operators are prone to errors, sometimes even leading to safety production accidents, seriously threatening the safety of the operators.

### SUMMARY

According to an embodiment of the present disclosure, a robot operating device includes a mobile vehicle, a guide rail installed on the mobile vehicle, and a plurality of robots slidably installed on the guide rail and movable along the guide rail. The mobile vehicles each include a mobile base having a roller at a bottom thereof, and a fixed bracket installed on the mobile base. The guide rail is fixedly installed on the fixed bracket and extends in a straight line along a horizontal direction. The plurality of robots are adapted to manipulate a product manufacturing machine to manufacture products.

### BRIEF DESCRIPTION OF THE DRAWINGS

The invention will now be described by way of example with reference to the accompanying Figures, of which:

FIG. 1 is an illustrative view of a robot operating device according to an exemplary embodiment of the present invention; and

FIG. 2 is an illustrative view of using a robot operating device to manipulate a product manufacturing machine according to an exemplary embodiment of the present invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A robot operating device according to an embodiment of the present disclosure includes a mobile vehicle, a guide rail installed on the mobile vehicle, and a plurality of robots which are slidably installed on the guide rail and adapted to move along the guide rail. The plurality of robots collaborate with each other and are adapted to manipulate a product manufacturing machine to manufacture products through the product manufacturing machine. The plurality of robots are also adapted to collaborate with the product manufacturing machine to complete the manufacturing of the product together with the product manufacturing machine. The mobile vehicle includes a mobile base which is equipped with a roller at the bottom thereof, and a fixed bracket installed on the mobile base. The guide rail is fixedly installed on the fixed bracket and extends in a straight line along a horizontal direction.

According to another embodiment of the present disclosure, a product manufacturing system comprises a product manufacturing machine for manufacturing products, and the above robot operating device. The plurality of robots of the robot operating device are adapted to manipulate the product manufacturing machine to complete the manufacturing of the product.

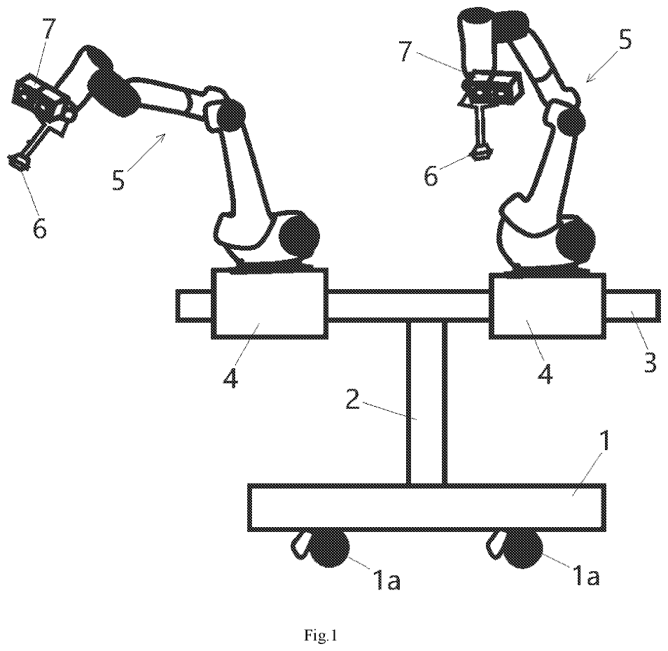

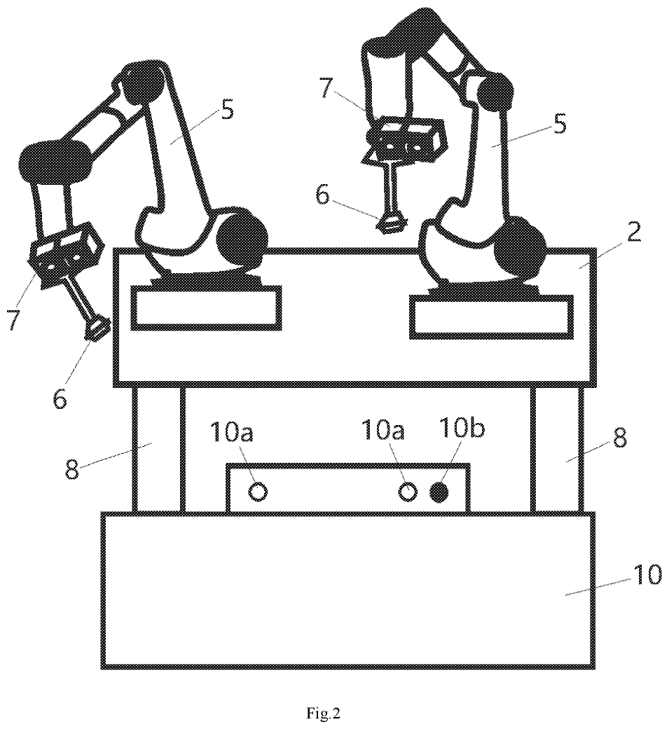

FIG. 1 is an illustrative view of a robot operating device 1 according to an exemplary embodiment of the present invention. FIG. 2 is an illustrative view of using a robot operating device to manipulate a product manufacturing machine 10 according to an exemplary embodiment of the present invention.

As shown in FIGS. 1 and 2, in an exemplary embodiment of the present invention, the robot operating device includes a mobile vehicle 1, 2, a guide rail 3, and a plurality of robots 5. The guide rail 3 is installed on the mobile vehicle 1, 2. The plurality of robots 5 are slidably installed on the guide rail 3 so as to be able to move along the guide rail. The plurality of robots 5 collaborate with each other and are used to manipulate the product manufacturing machine 10 to complete product manufacturing.

The mobile vehicle 1, 2 enables the plurality of robots 5 to move freely. For example, the plurality of robots 5 can be moved to different production workshops or different product manufacturing machines 10. In addition, in the illustrated embodiment, each robot 5 is able to move freely along the guide rail 3 within a predetermined range. This enables each robot 5 to move to different working areas, greatly improving production flexibility. The plurality of robots 5 are also used to collaborate with the product manufacturing machine 10 to complete the manufacturing of the product together with the product manufacturing machine 10.

The mobile vehicle 1, 2 includes a mobile base 1 and a fixed bracket 2. A roller 1a is installed at the bottom of mobile base 1. The fixed bracket 2 is installed on the mobile base 1. The guide rail 3 is fixedly installed on the fixed bracket 2 and extends along a horizontal direction in a straight line.

The robot operating device further includes a plurality of sliders 4, which are slidably mated with the guide rail 3. The plurality of robots 5 are respectively fixed to the plurality of sliders 4 so as to be slidably installed on the guide rail 3 through sliders. The robot operating device further includes a plurality of drivers (such as servo drivers or cylinders), which are installed on the mobile vehicle 1, 2 to drive the plurality of robots 5 to move along the guide rail 3.

As shown in FIGS. 1 and 2, in the illustrated embodiment, at least two robots among the plurality of robots 5 are identical. However, the present invention is not limited to this, for example, at least two robots among the plurality of robots 5 can be different from each other. In the exemplary illustrated embodiment, each of the robots 5 is a multi-degree of freedom robot with at least two degrees of freedom. For example, the robot 5 can be a six-axis robot with six degrees of freedom.

The robot operating device further includes an actuator 6, which can be detachably installed on a mounting seat at the end of the robot 5 for performing a predetermined operation. In an exemplary embodiment of the present invention, the actuator 6 may be a gripper adapted to grasp and move a product component used for manufacturing the product and/or adapted to grasp and move the manufactured product. In an exemplary embodiment of the present invention, the actuator 6 can be a bionic hand adapted to simulate human hands pressing various operation buttons 10a, 10b, and/or manipulating various operation levers on the product manufacturing machine 10.

As shown in FIGS. 1 and 2, in the illustrated embodiment, the robot operating device further includes a visual device 7. The visual device 7 is installed on the robot 5 to provide visual guidance for the robot.

The robot operating device further includes a fixing device 8 adapted to fix the mobile vehicle 1, 2 to the product manufacturing machine 10 to prevent the mobile vehicle from being moved relative to the product manufacturing machine 10 during product manufacturing. The fixing device 8 is a connecting device suitable for detachably connecting the mobile vehicle 1, 2 to the product manufacturing machine 10. However, the present invention is not limited to the illustrated embodiments. For example, the fixing device 8 can also be a locking device suitable for locking the mobile vehicle 1, 2 to the product manufacturing machine 10.

The robot operating device may include a single guide rail 3, with the plurality of robots 5 are slidably mounted on the single guide rail 3. However, the present invention is not limited to the illustrated embodiments. For example, in another exemplary embodiment of the present invention, the robot operating device may include a plurality of guide rails 3 extending in different directions, with at least one robot 5 slidably mounted on each guide rail.

In another exemplary embodiment of the present invention, a product manufacturing system is also disclosed. The product manufacturing system includes the product manufacturing machine 10 and the above robot operating device. The product manufacturing machine 10 is used to manufacture products. The plurality of robots 5 of the robot operation device are used to manipulate the product manufacturing machine 10 to complete the manufacturing of the product. The plurality of robots 5 in the robot operating device are also used to collaborate with the product manufacturing machine 10 to complete the manufacturing of the product together with the product manufacturing machine 10.

In the illustrated embodiments, the robot operating device and the product manufacturing machine 10 are controlled separately, so that there is no communication between the product manufacturing machine 10 and the robot operating device.

As shown in FIGS. 1 and 2, in the illustrated embodiment, a plurality of start buttons 10a and one stop button 10b are provided on the product manufacturing machine 10. For safety reasons, the product manufacturing machine 10 can only be started when the plurality of start buttons 10a are pressed simultaneously. In the illustrated embodiment, the plurality of robots 5 in the robot operating device can simultaneously press the plurality of start buttons 10a to start the product manufacturing machine 10.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A robot operating device, comprising:
a mobile vehicle;
a guide rail installed on the mobile vehicle; and
a plurality of robots slidably installed on the guide rail and movable along the guide rail, the plurality of robots adapted to collaborate with each other and to manipulate a product manufacturing machine to manufacture products through the product manufacturing machine.

2. The robot operating device according to claim 1, wherein the mobile vehicle includes:
a mobile base having a roller at the bottom thereof; and
a fixed bracket installed on the mobile base, the guide rail fixedly installed on the fixed bracket and extends along a horizontal direction.

3. The robot operating device according to claim 1, further comprising a plurality of sliders mated with the guide rail, wherein the plurality of robots are respectively fixed to the plurality of sliders and are slidable along the guide rail through the sliders.

4. The robot operating device according to claim 1, further comprising a plurality of drivers installed on the mobile vehicle and adapted to drive the plurality of robots to move along the guide rail.

5. The robot operating device according to claim 1, wherein at least two robots among the plurality of robots are identical to each other.

6. The robot operating device according to claim 1, wherein each robot is a multi-degree of freedom robot with at least two degrees of freedom.

7. The robot operating device according to claim 1, further comprising an actuator detachably installed on a mounting seat at an end of the robot for performing a predetermined operation.

8. The robot operating device according to claim 7, wherein the actuator is a gripper adapted to at least one of grip and move a product component for manufacturing the product or grip and move the manufactured product.

9. The robot operating device according to claim 7, wherein the actuator is a biomimetic hand adapted to simulate human hands at least one of pressing various operating buttons on the product manufacturing machine or manipulating various operating levers on the product manufacturing machine.

10. The robot operating device according to claim 7, further comprising a visual device installed on the robot and adapted to provide visual guidance for the robot.

11. The robot operating device according to claim 1, further comprising a fixing device adapted to fix the mobile vehicle to the product manufacturing machine to prevent the mobile vehicle from being moved relative to the product manufacturing machine during the manufacturing of the product.

12. The robot operating device according to claim 11, wherein the fixing device is a connecting device adapted to detachably connect the mobile vehicle to the product manufacturing machine.

13. The robot operating device according to claim 11, wherein the fixing device is a locking device adapted to lock the mobile vehicle to the product manufacturing machine.

14. The robot operating device according to claim 1, wherein the robot operating device includes only a single one of the guide rails, and the plurality of robots are slidably mounted on the single guide rail.

15. The robot operating device according to claim 1, wherein the robot operating device includes a plurality of the guide rails extending in different directions, and at least one robot is slidably installed on each guide rail.

16. A product manufacturing system, comprising:
a product manufacturing machine for manufacturing products; and
a robot operating device, including:
a mobile vehicle;
a guide rail installed on the mobile vehicle; and
a plurality of robots slidably installed on the guide rail and movable along the guide rail, the plurality of robots adapted to collaborate with each other and to manipulate a product manufacturing machine to manufacture products through the product manufacturing machine.

17. The product manufacturing system according to claim 16, wherein the mobile vehicle includes:
a mobile base having a roller at the bottom thereof; and
a fixed bracket installed on the mobile base, the guide rail fixedly installed on the fixed bracket and extends along a horizontal direction, wherein:
the guide rail is fixedly installed on the fixed bracket and extends in a straight line along a horizontal direction; and
the plurality of robots of the robot operating device are adapted to manipulate the product manufacturing machine to complete the manufacturing of the product.

18. The product manufacturing system according to claim 17, wherein the plurality of robots of the robot operating device are adapted to collaborate with the product manufacturing machine to complete the manufacturing of the product together with the product manufacturing machine.

19. The product manufacturing system according to claim 17, wherein the robot operating device and the product manufacturing machine are separately controlled, such that there is no communication between the product manufacturing machine and the robot operating device.

20. The product manufacturing system according to claim 17, wherein:
the product manufacturing machine is equipped with a plurality of start buttons and is started only when the plurality of start buttons are simultaneously pressed; and
the plurality of robots of the robot operating device are adapted to simultaneously press the plurality of start buttons to start the product manufacturing machine.
